(19) United States
(12) Patent Application Publication
(10) Pub. No.: US 2025/0183681 A1
(43) Pub. Date: Jun. 5, 2025

(54) Battery Apparatus, Battery Management System, And Method For Setting Precharge Period

(71) Applicant: LG Energy Solution, Ltd., Seoul (KR)

(72) Inventor: Hojoon Lee, Daejeon (KR)

(73) Assignee: LG Energy Solution, Ltd., Seoul (KR)

(21) Appl. No.: 18/701,435

(22) PCT Filed: Sep. 23, 2022
(86) PCT No.: PCT/KR2022/014260

§ 371 Date: Apr. 15, 2024

(30) Foreign Application Priority Data
Nov. 1, 2021 (KR) 10-2021-0147896

(51) Int. Cl. H02J 7/00; H02J 7/34

(52) U.S. Cl. CPC H02J 7/00304; H02J 7/0047; H02J 7/0063; H02J 7/007182; H02J 7/345

(57) ABSTRACT

A processor of a battery device is configured to estimate a target time of a precharge duration in each of a plurality of cycles, and set a time of the precharge duration of a next cycle of the plurality of cycles based on the estimated target time in each of the plurality of cycles.

### CROSS-REFERENCE TO RELATED APPLICATION

The present application is a national phase entry under 35 U.S.C. § 371 of International Application No. PCT/KR2022/014260 filed Sep. 23, 2022, which claims priority from Korean Patent Application 10-2021-0147896 filed Nov. 1, 2021, all of which are incorporated herein by reference.

### TECHNICAL FIELD

The disclosure relates to a battery device, a battery management system, and a precharge duration setting method.

### BACKGROUND ART

Electric vehicles and hybrid vehicles are vehicles obtaining power by mainly using batteries as power sources for driving motors, and are alternatives capable of solving pollution and energy problems of internal combustion vehicles. For this reason, research has been actively carried out on them. Further, rechargeable batteries have been used in vehicles and even in various other external apparatuses.

Recently, as high-power high-capacity batteries have been needed, battery packs including a plurality of battery cells connected in series or parallel have been used. Furthermore, the potential risk of battery packs has increased as their power and capacity have increased. Particularly, when an overcurrent flows in a battery pack, if the overcurrent is not diagnosed, due to the overcurrent, problems may occur in external devices.

In order to prevent rush current of such overcurrent which is generated in the initial stage of driving, precharge circuits have been used. Precharge circuits can prevent rush current by first charging capacitors connected to inverters and so on of external devices through precharge resistors in the initial stage of driving. By the way, if the time that it takes to precharge a capacitor is not sufficient, a main switch may be closed in the state where the capacitor has not been charged to a sufficient voltage. In this case, the main switch may be damaged due to the difference between the voltage of the battery pack and the voltage of the capacitor.

### SUMMARY

### Technical Problem

The present disclosure has been made in an effort to provide a battery device, a battery management system, and a precharge duration setting method having merits of being capable of minimizing damage to a main switch.

### Technical Solution

An embodiment provides a battery device including a positive connection terminal and a negative connection terminal which are connected to an external device. The battery device may include a battery pack, a positive main switch, a precharge switch, and a processor. The positive main switch may be connected between the positive terminal of the battery pack and a positive connection terminal. The precharge switch may be connected between the positive terminal of the battery pack and the positive connection terminal to control a precharge operation of a capacitor of the external device. The processor may be configured to estimate a target time of a precharge duration in each of a plurality of cycles, and set a time of a next precharge duration of a next cycle of the plurality of cycles based on the estimated target times.

In some embodiments, the processor may be configured to set a maximum value of the estimated target times as the time of the next precharge duration of the next cycle.

In some embodiments, in each cycle, the processor may be configured to perform the precharge operation by closing the precharge switch during the precharge duration, and close the positive main switch after the precharge operation is complete, and estimate the target time based on a first voltage of the positive connection terminal in response to the positive main switch being ready to close and a second voltage of the positive connection terminal in response to the positive main switch being closed.

In some embodiments, the battery device may further include a precharge resistor that is connected between the positive terminal and the positive connection terminal when the precharge switch is closed.

In some embodiments, the precharge switch and the precharge resistor may be connected in series.

In some embodiments, the processor may be configured to estimate a time constant computed by a resistance value of the precharge resistor and a capacitance of the capacitor based on the first voltage and the second voltage, and estimate a multiple of the time constant as the target time.

In some embodiments, the predetermined multiple may be 5 times the time constant.

In some embodiments, in a cycle in which the time of the precharge duration has not been set, the processor may be configured to set the time of the precharge duration of the corresponding cycle based on a time taken for the voltage of the positive connection terminal to reach a predetermined voltage in the precharge duration.

In some embodiments, the predetermined voltage may be a voltage computed based on a predetermined ratio to the voltage of the battery pack.

In some embodiments, the predetermined ratio may be determined based on the predetermined multiple of the time constant computed by the resistance value of the precharge resistor and the capacitance of the capacitor.

In some embodiments, in a cycle in which the time of the precharge duration has not been set, the processor may be configured to estimate the time constant based on a time taken for the voltage of the positive connection terminal to reach the predetermined voltage during the precharge duration, and set the predetermined multiple of the time constant as the time of the precharge duration of a corresponding cycle.

In some embodiments, the predetermined multiple may be 6 times the time constant.

Another embodiment provides a precharge duration setting method of a battery device including a battery pack, and a positive connection terminal and a negative connection terminal to be connected to an external device. The precharge duration setting method may include precharging a capacitor connected to the positive connection terminal and the negative connection terminal through a precharge resistor during a precharge duration of each of a plurality of cycles, estimating a target time of the precharge duration in each of the plurality of cycles, and setting a time of the precharge duration of a next cycle of the plurality of cycles based on the estimated target times.

In some embodiments, the step of setting the time of the precharge duration may include setting a maximum value of the estimated target times as a next time of the precharge duration of a next cycle.

In some embodiments, estimating the target time may include applying the voltage of the battery pack to the positive connection terminal after completing the precharging, measuring the voltage of the positive connection terminal as a first voltage in response to the voltage of the battery pack being ready to apply, measuring the voltage of the positive connection terminal as a second voltage in response to the voltage of the battery pack being applied, and a step of estimating the target time based on the first voltage and the second voltage.

In some embodiments, estimating the target time based on of the first voltage and the second voltage may include estimating a time constant computed by a resistance value of the precharge resistor and a capacitance of the capacitor, based on the first voltage and the second voltage, and estimating a predetermined multiple of the time constant as the target time.

In some embodiments, the precharge duration setting method may include setting the time of the precharge duration of a cycle in which the time of the precharge duration has not been set based on a time taken for the voltage of the positive connection terminal to reach a predetermined voltage, during the precharge duration of the corresponding cycle.

Yet another embodiment provides a battery management system of a battery device including a battery pack, and a positive connection terminal and a negative connection terminal to be connected to an external device. The battery management system may include a positive main switch, a precharge switch, and a processor. The positive main switch may be connected between a positive terminal of the battery pack and the positive connection terminal. The precharge switch may be connected between the positive terminal of the battery pack and the positive connection terminal to control the precharge operation of a capacitor of the external device. The processor may be configured to estimate a target time of a precharge duration in each of a plurality of cycles, and set a time of a precharge duration of a next cycle of the plurality of cycles based on the estimated target times.

In some embodiments, it is possible to set a precharge duration capable of minimizing damage to a main switch.

### BRIEF DESCRIPTION OF THE DRAWINGS

FIG. 1 is a drawing illustrating a battery device according to an embodiment.

FIG. 2 is a drawing illustrating switching timings in the battery device according to the embodiment.

FIG. 3 is a flow chart illustrating an example of a precharge duration setting method of a battery device according to an embodiment.

FIG. 4 is a drawing illustrating an example of an equivalent circuit of a battery device according to an embodiment during a precharge duration.

FIG. 5 is a drawing illustrating an example of the voltage of a positive connection terminal in a battery device according to an embodiment.

FIG. 6 is a drawing illustrating voltage ratios depending on multiples of a time constant.

FIG. 7 is a flow chart illustrating an example of a method of setting an initial value of a precharge time in a battery device according to another embodiment.

### DETAILED DESCRIPTION

In the following detailed description, only certain embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

It should be understood that when a constituent element is referred to as being “connected” to another constituent element, it may be directly connected to the other constituent element, or other constituent elements may be present between them. In contrast, it should be understood that when a constituent element is referred to as being “directly connected” to another constituent element, there is no other constituent element between them.

In the following description, expressions written in the singular forms can be comprehended as the singular forms or plural forms unless clear expressions such as “a”, “an”, or “single” are used.

In the flow charts described with reference to the drawings, the order of operations may be changed, and several operations may be combined, and an operation may be divided, and some operations may not be performed.

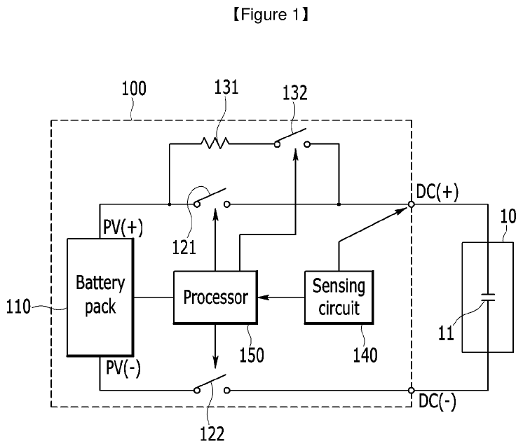

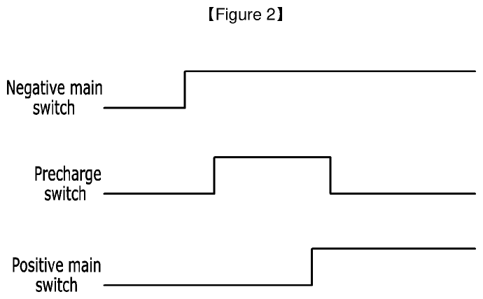

FIG. 1 is a drawing illustrating a battery device according to an embodiment, and FIG. 2 is a drawing illustrating switching timings in the battery device according to the embodiment.

Referring to FIG. 1, a battery device 100 has such a structure that it can be electrically connected to an external device 10 through a positive connection terminal DC(+) and a negative connection terminal DC (−). In the case where the external device is a load, the battery device 100 operates as a power source for supplying power to the load, thereby being discharged. The external device 10 operating as a load may be, for example, an electronic apparatus, a transportation means, or an energy storage system (ESS), and the transportation means may be, for example, an electric vehicle, a hybrid vehicle, or smart mobility.

The battery device 100 includes a battery pack 110, a switch circuit, a precharge circuit, a sensing circuit 140, and a processor 150.

The battery pack 110 includes a plurality of battery cells (not shown in the drawings), and has a positive terminal PV(+) and a negative terminal PV (−). In some embodiments, the battery cells may be secondary batteries which are rechargeable. In an embodiment, in the battery pack 110, a predetermined number of battery cells may be connected in series to constitute a battery module, and supply desired power. In another embodiment, in the battery pack 110, a predetermined number of battery modules may be connected in series or in parallel, and supply desired power.

The switch circuit includes a positive main switch 121 connected between the positive terminal PV(+) of the battery pack 110 and the positive connection terminal DC(+) of the battery device 100, and a negative main switch 122 connected between the negative terminal PV (−) of the battery pack 110 and the negative connection terminal DC (−) of the battery device 100. In an embodiment, each of the switches 121 and 122 may be a contactor composed of a relay. In another embodiment, each of the switches 121 and 122 may be an electric switch such as a transistor. In some embodiments, the switch circuit may further include driver circuits (not shown in the drawings) which control the switches 121 and 122, respectively.

The precharge circuit is connected between the positive terminal PV(+) of the battery pack 110 and the positive connection terminal DC(+) of the battery device 100, and can first charge a capacitor 11 of the external device 10 which is connected to the connection terminals DC(+) and DC (−) during a precharge duration. In some embodiments, the precharge circuit may include a precharge resistor 131 and a precharge switch 132. In the case where the precharge switch 132 is closed, the precharge resistor 131 can be connected between the positive terminal PV(+) of the battery pack 110 and the positive connection terminal DC(+) of the battery device 100. Accordingly, the precharge circuit can first charge the capacitor 11 of the external device 10 through the precharge resistor 131. In some embodiments, the precharge resistor 131 and the precharge switch 132 may be connected in series between the positive terminal PV(+) of the battery pack 110 and the positive connection terminal DC(+) of the battery device 100. In an embodiment, the precharge switch 132 may be a contactor composed of a relay. In another embodiment, the precharge switch 132 may be an electric switch such as a transistor. In some embodiments, the precharge circuit may further include a driver circuit (not shown in the drawings) which controls the precharge switch 132.

The sensing circuit 140 senses the voltage on a predetermined point in the battery device 100. In some embodiments, the sensing circuit 140 may sense the voltage of the positive connection terminal DC(+) of the battery device 100. In some embodiments, the sensing circuit 140 may include a plurality of resistors (not shown in the drawings) connected in series between the positive connection terminal DC(+) and a ground terminal. In this case, the sensing circuit 140 may sense a voltage obtained by dividing the voltage of the positive connection terminal DC(+) by the plurality of resistors, as the voltage of the positive connection terminal DC(+). In some embodiments, the sensing circuit 140 may further include an analog-to-digital converter which converts the voltage obtained by the voltage division using the plurality of resistors into a digital signal, and transmits the digital signal to the processor 150.

The processor 150 may control the operations of the switches 121, 122, and 132. Further, the processor 150 may set a precharge duration on the basis of the voltage sensed by the sensing circuit 140. In some embodiments, the processor 150 may diagnose the capacitance of the capacitor 11 on the basis of the voltage sensed by the sensing circuit 140. In some embodiments, the processor 150 may be, for example, a micro controller unit (MCU).

In some embodiments, the sensing circuit 140 and the processor 150 may be included in a battery management system (BMS) of the battery device.

Referring to FIG. 2, during initial driving of the battery device, the processor 150 first closes the negative main switch 122. Next, the processor 150 closes the precharge switch 132 in the state where the negative main switch 122 is closed. Accordingly, precharge current can be supplied to the capacitor 11 of the external device 10 through the precharge resistor 131, whereby the capacitor 11 can be charged. The duration when the precharge switch 132 is closed, whereby the capacitor 11 is charged may be referred to as a precharge duration.

Next, after charging the capacitor 11 of the external device 10, the processor 150 closes the positive main switch 121 in order to transmit the voltage of the battery pack 110 to the external device 10. In this case, since precharge has been completed, the processor 150 can open the precharge switch 132. Therefore, it is possible to prevent rush current from occurring when the voltage of the battery pack 110 is supplied to the external device 10 by the voltage to which the capacitor 11 of the external device 10 has been charged. Closing a switch may be referred to as turning on the switch, and opening a switch may be referred to as turning off the switch.

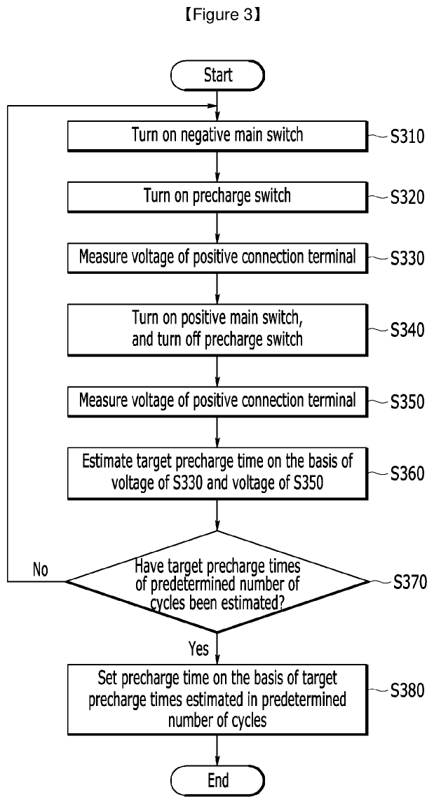

Now, precharge duration setting methods according to various embodiments will be described with reference to FIG. 3 to FIG. 6.

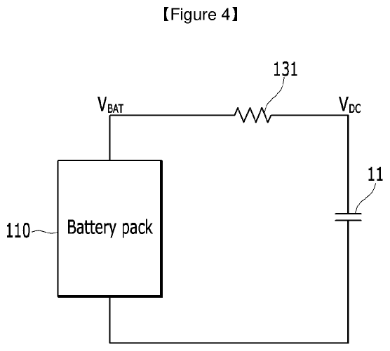

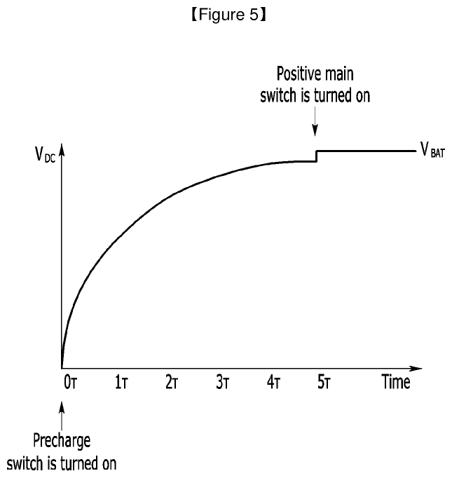

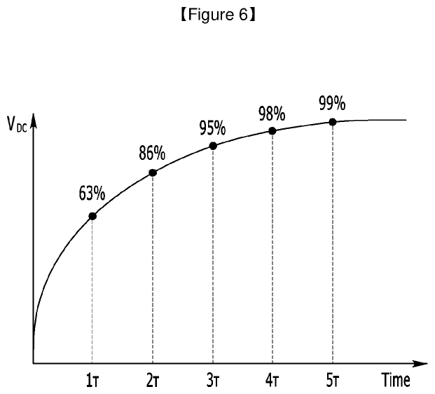

FIG. 3 is a flow chart illustrating an example of a precharge duration setting method of a battery device according to an embodiment, and FIG. 4 is a drawing illustrating an example of an equivalent circuit of a battery device according to an embodiment during a precharge duration. FIG. 5 is a drawing illustrating an example of the voltage of a positive connection terminal in a battery device according to an embodiment, and FIG. 6 is a drawing illustrating voltage ratios depending on multiples of a time constant.

Referring to FIG. 3, the processor (for example, 150 in FIG. 1) of the battery device closes the negative main switch (for example, 122 in FIG. 1) (S310), and closes the precharge switch (for example, 132 in FIG. 1) (S320). Accordingly, a precharge duration starts, and the capacitor of the external device (for example, 11 in FIG. 1) can be charged.

After performing the precharge operation (for example, when the precharge duration ends), the processor 150 closes the positive main switch (for example, 121 in FIG. 1) (S340). The processor 150 may apply the voltage of the battery pack 110 to the positive connection terminal DC(+) by closing the positive main switch 121. Immediately before closing the positive main switch 121 (for example, immediately before applying the voltage of the battery pack 110 to the positive connection terminal DC(+)), the processor 150 measures the voltage of the positive connection terminal (for example, DC(+)) of the battery device sensed by the sensing circuit (for example, 140 in FIG. 1) (S330). Further, immediately after closing the positive main switch 121 (for example, immediately after applying the voltage of the battery pack 110 to the positive connection terminal DC(+)), the processor 150 measures the voltage of the positive connection terminal (DC(+)) of the battery device sensed by the sensing circuit 140 (S350). In some embodiments, after closing the positive main switch 121, the processor 150 may open the precharge switch 132 (S340).

The processor 150 estimates a target time of the precharge duration (hereinafter, referred to as a “target precharge time”), on the basis of the voltage of the positive connection terminal (DC(+)) of the battery device measured immediately before it closed the positive main switch 121 and the voltage of the positive connection terminal (DC(+)) of the battery device measured immediately after it closed the positive main switch 121 (S360). In some embodiments, the processor 150 may store the estimated target precharge time as the target precharge time of the current cycle.

The processor 150 sets the time of the precharge duration (hereinafter, referred to as the “precharge time”) of the next cycle, on the basis of the target precharge time (S370, S380). In some embodiments, the processor may set the precharge time of the next cycle, on the basis of the target precharge times of a plurality of cycles. To this end, the processor 150 may determine whether each of the target precharge times of a predetermined number of cycles has been estimated (S370). In the case where the target precharge times of the predetermined number of cycles have not been estimated (S370), the processor 150 may repeat the procedure from S310 when the next cycle starts. In the case where the target precharge times of the predetermined number of cycles have been estimated (S370), the processor 150 may set the precharge time of the next cycle, on the basis of the target precharge times estimated in the predetermined number of cycles (S380). In some embodiments, the processor 150 may set the maximum value of the target precharge times estimated in the predetermined number of cycles, as the precharge time of the next cycle (S380). In some embodiments, the predetermined number may be 5.

Meanwhile, as shown in FIG. 4, when the precharge switch 132 is closed, an RC equivalent circuit may be formed by the battery pack 110, the precharge resistor 131, and the capacitor 11. Then, the voltage of the capacitor 11, that is, the voltage V_{DC} of the positive connection terminal DC(+) increases on the basis of the time constant t of an RC equivalent circuit 410, as shown in FIG. 5. The voltage V_{DC} of the capacitor 11 may vary, for example, as Equation 1.

$${V}_{DC} = {V}_{BAT} ( 1 - {e}^{- t / τ} ) \qquad ( Equation 1 )$$

In Equation 1, the time constant τ is defined as the product of the resistance value R_{P} of the precharge resistor 131 and the capacitance C_{EX} of the capacitor 11.

As shown in FIG. 5, immediately after the positive main switch 121 is closed, the voltage of the positive connection terminal DC(+) is changed to the voltage V_{BAT} of the battery pack 110. The voltage of the positive connection terminal DC(+) measured immediately after the positive main switch 121 was closed corresponds to the voltage V_{BAT} of the battery pack 110. Therefore, the processor 150 may estimate the time constant on the basis of the voltage V_{DC} of the positive connection terminal DC(+) measured immediately before the positive main switch 121 was closed (the voltage of the capacitor 11 measured when the precharge duration ended), and the voltage V_{BAT} of the positive connection terminal DC(+) (the voltage of the battery pack 110) measured immediately after the positive main switch 121 was closed. For example, the time constant t can be calculated from Equation 1 by setting the voltage of the positive connection terminal DC(+) measured immediately before the positive main switch 121 was closed, the voltage of the positive connection terminal DC(+) measured immediately after the positive main switch 121 was closed, and the precharge duration of the current cycle as V_{DC}, V_{BAT}, and τ, respectively.

Therefore, the processor 150 may set a target precharge time on the basis of the time constant τ. In some embodiments, the processor 150 may set n times the time constant as the target precharge time (wherein n is a positive real number). As shown in FIG. 6, in the equivalent circuit shown in FIG. 4, the voltage V_{DC} of the capacitor 11 at 1 times the time constant (τ) corresponds to 63% of the voltage V_{BAT} of the battery pack 110, and the voltage V_{DC} of the capacitor 11 at 2 times the time constant (2τ) corresponds to 86% of the voltage V_{BAT} of the battery pack 110, and the voltage V_{DC} of the capacitor 11 at 3 times the time constant (3τ) corresponds to 95% of the voltage V_{BAT} of the battery pack 110, and the voltage V_{DC} of the capacitor 11 at 4 times the time constant (4τ) corresponds to 98% of the voltage V_{BAT} of the battery pack 110, and the voltage V_{DC} of the capacitor 11 at 5 times the time constant (5τ) corresponds to 99% of the voltage V_{BAT} of the battery pack 110. For example, the processor 150 may set 5 times the time constant (5τ) at which the voltage V_{DC} of the capacitor 11 becomes 99% of the voltage V_{BAT} of the battery pack 110, as the target precharge time. In the case of setting 5 times the time constant (5τ) as the target precharge time, since the positive main switch 121 is closed when the voltage V_{DC} of the positive connection terminal DC(+) reaches 99% of the voltage V_{BAT} of the battery pack 110, damage to the positive main switch 121 can be minimized. Besides, in some embodiments, in the case where the maximum value of target precharge times of a plurality of cycles is selected, it is possible to select such a time that damage to the positive main switch 121 can be minimized, in consideration of the deviation of measurements in the plurality of cycles.

According to the embodiments described above, the precharge time is set on the basis of the target precharge times estimated in the predetermined number of cycles. Therefore, it is possible to set an accurate precharge time. In this case, even if the capacitance of the capacitor varies, the precharge time can be adaptively set. Further, since the voltage of the positive connection terminal DC(+) is measured immediately before the positive main switch 121 is closed and immediately after the positive main switch 121 is closed, it is possible to minimize the difference between the two voltage measurement time points. In other words, since the two voltage measurements are performed in substantially the same environment, it is possible to minimize errors in elements related to voltage measurement, thereby accurately estimating the time constant.

As described above, the processor 150 may set a precharge time in the next cycle, on the basis of the target precharge times estimated in the predetermined number of cycles, respectively. Therefore, the precharge time of the current cycle may be set on the basis of the target precharge times estimated in the predetermined number of previous cycles, respectively. For example, the precharge time of the i-th cycle may be set on the basis of the target precharge times estimated in the (i-5)-th to (i-1)-th cycles, respectively. On the other hand, there may be a case where the target precharge times of the predetermined number of previous cycles required to set the precharge time of the current cycle are not stored. For example, in the first cycle, since no previous cycle has been performed, target precharge times of previous cycles may not exist. Further, even in the second to fifth cycles, since the predetermined number of previous cycles have not been performed, target precharge times of the predetermined number of previous cycles may not exist. In this case, the precharge time of the current cycle may not be set.

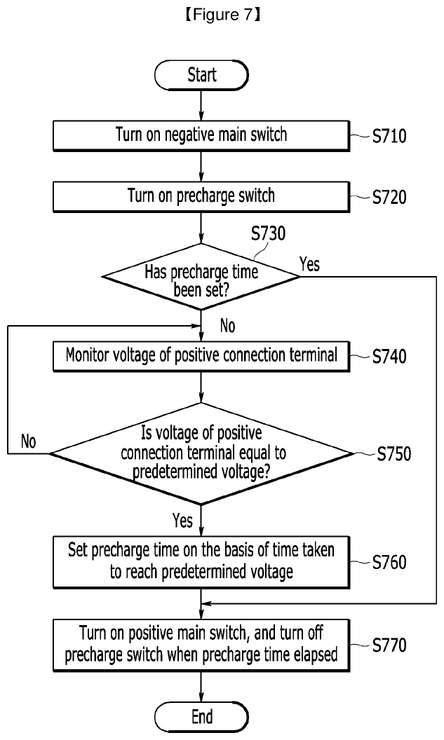

Hereinafter, an embodiment in which when the precharge time of the current cycle has not been set, the precharge time is set will be described with reference to FIG. 7.

FIG. 7 is a flow chart illustrating an example of a method of setting an initial value of a precharge time in a battery device according to another embodiment.

Referring to FIG. 7, the processor of the battery device (for example, reference numeral 150 in FIG. 1) closes the negative main switch (for example, reference numeral 122 in FIG. 1) (S710), and closes the precharge switch (for example, reference numeral 132 in FIG. 1) (S720). Accordingly, a precharge duration starts, and the capacitor of the external device (for example, reference numeral 11 in FIG. 1) can be charged. In some embodiments, when a precharge duration starts, the processor 150 may activate a timer to measure the elapsed time of the precharge duration. For example, the processor 150 may activate the timer when closing the precharge switch 132.

The processor 150 determines whether the precharge time of the current cycle has been set (S730). In some embodiments, the processor 150 may determine whether the precharge time of the current cycle has been set, on the basis of the target precharge times of the predetermined number of previous cycles (S730). In some embodiments, the processor 150 may compare the number of previous cycles in which target precharge times have been estimated, with the predetermined number (S730).

In the case where the precharge time of the current cycle has not been set (S730), the processor 150 monitors the voltage V_{DC} of the positive connection terminal (for example, DC(+)) of the battery device through the sensing circuit (for example, 140 in FIG. 1) (S740). While monitoring the voltage V_{DC} of the positive connection terminal DC(+), the processor 150 compares the voltage of the positive connection terminal DC(+) with a predetermined voltage (S750). The predetermined voltage is a voltage determined on the basis of the voltage V_{BAT} of the battery pack (for example, 110 in FIG. 1). In some embodiments, the sensing circuit 140 may sense the voltage of the positive terminal PV(+) of the battery pack 110, whereby the processor 150 may measure the voltage V_{BAT} of the battery pack 110. In some embodiments, the predetermined voltage may be set on the basis of the voltage V_{BAT} of the battery pack 110 and m times the time constant (wherein m is a positive real number). In some embodiments, the predetermined voltage may be set such that the ratio of the predetermined voltage to the voltage V_{BAT} of the battery pack 110 is equal to the ratio of the voltage of the capacitor 11 to the voltage V_{BAT} of the battery pack 110 that is obtained in the equivalent circuit shown in FIG. 4 when the precharge time corresponding to m times the time constant elapses. For example, as the predetermined voltage, 86% of the voltage V_{BAT} of the battery pack 110, that is, 0.86V_{BAT} may be set on the basis of 2 times the time constant.

In the case where the voltage of the positive connection terminal DC(+) reaches the predetermined voltage (S750), the processor 150 sets the precharge time (initial precharge time) of the current cycle on the basis of the time taken for the voltage of the positive connection terminal DC(+) to reach the predetermined voltage (S760). In some embodiments, the processor 150 may set the initial precharge time on the basis of the time taken for the voltage V_{BAT} of the battery pack 110 to reach the predetermined voltage and m times the time constant used to set the predetermined voltage (S760). In some embodiments, the processor 150 may set k times the time taken for the voltage V_{BAT} of the battery pack 110 to reach the predetermined voltage, as the initial precharge time (wherein k is a positive real number). In this case, the initial precharge time may be set to (k*m) times the time constant. In some embodiments, (k*m) may be set to be larger than n times the time constant used to set the above-described target precharge time. For example, in the case where the target precharge time is set to 5 times the time constant (n=5), and the predetermined voltage is set on the basis of 2 times the time constant (m=2), the initial precharge time may be set to 6 times the time constant (k=3). As described above, the initial precharge time is set to be long. Therefore, it is possible to minimize damage to the positive main switch (for example, 121 in FIG. 1) attributable to errors in voltage measurement.

In the case where the initial precharge time is set (S760), when the initial precharge time set in S760 elapses from the time when the precharge duration starts, the processor 150 closes the positive main switch 121 (S770). In the case where the precharge time has been already set (S730), when the set precharge time elapses from the time when the precharge duration starts, the processor 150 closes the positive main switch 121 (S770). Accordingly, the precharge duration ends. In some embodiments, the processor 150 may open the precharge switch 132 after closing the positive main switch 121 (S770).

In some embodiments, the processor 150 may measure the voltage of the positive connection terminal DC(+) of the battery device immediately before closing the positive main switch 121 as described with reference to FIG. 3, and measure the voltage of the positive connection terminal DC(+) of the battery device immediately after closing the positive main switch 121. The processor 150 may estimate the target precharge time of the current cycle on the basis of the voltage of the positive connection terminal DC(+) of the battery device measured immediately before it closed the positive main switch 121 and the voltage of the positive connection terminal DC(+) of the battery device measured immediately after it closed the positive main switch 121.

As described above, in the case where target precharge times in previous cycles are not estimated, an initial precharge time can be set.

While this disclosure has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A battery device having a positive connection terminal and a negative connection terminal to be connected to an external device, comprising:
a battery pack;
a positive main switch connected between a positive terminal of the battery pack and the positive connection term;
a precharge switch connected between the positive terminal of the battery pack and the positive connection terminal to control a precharge operation of a capacitor of the external device; and
a processor configured to estimate a target time of a precharge duration in each of a plurality of cycles, and set a time of a next precharge duration of a next cycle of the plurality of cycles based on the estimated target times.

2. The battery device of claim 1, wherein:
the processor is configured to set a maximum value of the estimated target times as the time of the next precharge duration of the next cycle.

3. The battery device of claim 1, wherein:
in each cycle, the processor is configured to:
perform the precharge operation by closing the precharge switch during the precharge duration;
closing the positive main switch after the precharge operation is complete; and
estimating the target time based on a first voltage of the positive connection terminal in response to the positive main switch being ready to close and a second voltage of the positive connection terminal in response to the positive main switch being closed.

4. The battery device of claim 3, further comprising:
a precharge resistor connected between the positive terminal and the positive connection terminal-when the precharge switch is closed.

5. The battery device of claim 4, wherein:
the precharge switch and the precharge resistor are connected in series.

6. The battery device of claim 4, wherein:
the processor is configured to:
estimate a time constant computed by a resistance value of the precharge resistor and a capacitance of the capacitor based on the first voltage and the second voltage; and
estimate a multiple of the time constant as the target time.

7. The battery device of claim 6, wherein:
the predetermined multiple is 5 times the time constant.

8. The battery device of claim 4, wherein:
in a cycle in which the time of the precharge duration has not been set, the processor is configured to set the time of the precharge duration of the corresponding cycle based on a time taken for the voltage of the positive connection terminal to reach a predetermined voltage in the precharge duration.

9. The battery device of claim 8, wherein:
the predetermined voltage is a voltage computed based on a predetermined ratio to the voltage of the battery pack.

10. The battery device of claim 9, wherein:
the predetermined ratio is determined based on the predetermined multiple of the time constant computed by the resistance value of the precharge resistor and the capacitance of the capacitor.

11. The battery device of claim 8, wherein:
in a cycle in which the time of the precharge duration has not been set, the processor is configured to estimates the time constant based on a time taken for the voltage of the positive connection terminal to reach the predetermined voltage during the precharge duration;
and sets the predetermined multiple of the time constant as the time of the precharge duration of a corresponding cycle.

12. The battery device of claim 11, wherein:
the predetermined multiple is 6 times the time constant.

13. A precharge duration setting method of a battery device including a battery pack, and a positive connection terminal and a negative connection terminal to be connected to an external device, comprising:
precharging a capacitor connected to the positive connection terminal and the negative connection terminal through a precharge resistor during a precharge duration of each of a plurality of cycles;
estimating a target time of the precharge duration in each of the plurality of cycles; and
setting a time of the precharge duration of a next cycle of the plurality of cycles based on the estimated target times.

14. The precharge duration setting method of claim 13, wherein:
setting the time of the precharge duration includes setting a maximum value of the estimated target times as a next time of the precharge duration of a next cycle.

15. The precharge duration setting method of claim 13, wherein:
estimating the target time includes:
applying the voltage of the battery pack to the positive connection terminal after completing the precharging;
measuring the voltage of the positive connection terminal as a first voltage in response to the voltage of the battery pack being ready to apply;
measuring the voltage of the positive connection terminal as a second voltage in response to the voltage of the battery pack being applied; and
estimating the target time based on the first voltage and the second voltage.

16. The precharge duration setting method of claim 13, wherein:
estimating the target time based on the first voltage and the second voltage includes:
estimating a time constant computed by a resistance value of the precharge resistor and a capacitance of the capacitor, based on the first voltage and the second voltage; and
estimating a predetermined multiple of the time constant as the target time.

17. The precharge duration setting method of claim 13, further comprising:
setting the time of the precharge duration of a cycle in which the time of the precharge duration has not been set based on a time taken for the voltage of the positive connection terminal to reach a predetermined voltage, during the precharge duration of the corresponding cycle.

18. A battery management system of a battery device including a battery pack, and a positive connection terminal and a negative connection terminal to be connected to an external device, comprising:
a positive main switch connected between a positive terminal of the battery pack and the positive connection terminal;
a precharge switch connected between the positive terminal of the battery pack and the positive connection terminal to control the precharge operation of a capacitor of the external device; and
a processor configured to estimates a target time of a precharge duration in each of a plurality of cycles, and sets a time of a precharge duration of a next cycle of the plurality of cycles based on the estimated target times.
